(19) United States
(12) Patent Application Publication
(10) Pub. No.: US 2009/0049694 A1
(43) Pub. Date: Feb. 26, 2009

(54) Electric shaver apparatus with actively cooled surface

(76) Inventor: Gary Jay Morris, Morgantown, WV (US)

Correspondence Address: Gary J. Morris, 2026 Glenmark Avenue, Morgantown, WV, 26505-2900, US

(21) Appl. No.: 11/894,404

(22) Filed: Aug. 21, 2007

(51) Int. Cl. B26B 19/16

(52) U.S. Cl. 30/43.6; 30/34.05

(57) ABSTRACT

An electric shaver apparatus and method are disclosed which incorporate an actively cooled surface to contact and cool the skin of a user to enhance the comfort of shaving. The actively cooled surface is provided by a thermoelectric cooler with a passive or active heat sink in the various embodiments.

### BACKGROUND OF THE INVENTION

1. Field of Invention

The various embodiments of this invention relate to an electric shaving implement and method for cutting body hair and providing an actively cooled surface in contact with the skin. The surface is actively cooled by thermoelectric cooling.

2. Background

Electric shavers and blade razors used to remove facial and body hair are known to often irritate the skin of the user, particularly in users having sensitive skin. For users with sensitive skin, one way to enhance the comfort of the use an electric shaver, or electric razor as they are sometimes called, is to apply a cooled surface to the skin as the hair is being cut away or soon thereafter. The cooled surface helps to soothe the skin that may be irritated by the friction and/or abrasive contact between the skin and the surfaces of the shaving head of the shaving implement. Embodiments of the present invention provide thermoelectrically cooled surfaces in or near the shaving head of shaving implements or on the shaver body housing to soothe the skin prior to shaving, during shaving or after shaving.

### SUMMARY OF THE INVENTION

The various embodiments of the invention described herein provide an actively cooled surface for contacting skin prior to, during, or after the process of shaving. The shaving head of an electric shaver houses the blades and the skin guard elements which permit hair to protrude through to the blades but protect the skin from the blades. The shaving head also includes the supporting structure and frame surrounding the skin guard elements covering the blades and may also include fasteners to attach the shaving head to the shaver body housing. The cooled surface provides enhanced comfort to the skin to soothe sensitive skin that is easily irritated by the motion of a shaving head across the surface of the skin. The actively cooled surface(s) in the various embodiments of the invention uses thermoelectric cooling to remove thermal energy from the actively cooled surface and to reject the thermal energy to a heat sink. The heat sink embodiments include, without limitation, phase change materials, heat transfer fins, solid masses, liquid masses, fans, etc. Thermoelectric elements are known electronic heat pumps utilizing the Peltier effect to transport thermal energy from a cold side of the element to a hot side of the element through the consumption of electrical energy.

### BRIEF DESCRIPTIONS OF THE DRAWINGS

FIG. 1 shows a multiple, rotary head electric shaver embodiment with a thermoelectric cooler system to cool at least some portion of the shaving head in contact with the skin.

FIG. 2 shows a multiple, rotary head electric shaver with a cooled surface protruding through the shaving head.

FIG. 3 shows a side view of a foil head electric shaver embodiment with a thermoelectric cooler system to cool a surface that contacts the skin.

FIG. 4 shows a rear view of the foil head electric shaver embodiment shown in FIG. 3.

FIG. 5 shows a side view of a foil head electric shaver embodiment with a thermoelectric cooler system to cool the foil head which makes contact with the skin.

FIG. 6 shows an electric shaver with a thermally conductive body on the exterior of the shaver body housing.

FIG. 7 shows detail of the thermoelectric cooler system including a thermoelectric cooler, a cold side conductive member with a temperature sensor, and a hot side heat sink system.

FIG. 8 shows detail of a heat sink system configuration comprising a finned heat sink element and a fan to move air across the element.

FIG. 9 shows a flow chart of a method to electronically control the cold side temperature of a thermoelectric cooler.

### DETAILED DESCRIPTION OF THE EMBODIMENTS

Through the application of the Peltier effect well known thermoelectric elements, which are often called thermoelectric coolers in cooling applications or TEC for short, transport thermal energy from one face (cold side) of the thermoelectric cooler to another face (hot side) of the element as electrical current is passed through the element. This effect is quite useful to provide a cooled surface without the need for moving parts or working fluids such as refrigerants within the confines of the element. By applying a proper heat sink to the hot side of the thermoelectric cooler to absorb thermal energy and/or reject thermal energy to the surroundings, the cold side of the cooler may absorb thermal energy thereby providing active cooling of a surface in contact with the cold side of the cooler. The hot side of a thermoelectric cooler is the side of the cooler that rejects thermal energy while the cold side of the thermoelectric cooler is the side of the cooler that absorbs thermal energy. Thermoelectric coolers can be stacked to increase their overall effectiveness by contacting the hot side of a first cooler to the cold side of a second cooler.

In the various embodiments of the present invention, an electric shaver is equipped with at least one thermoelectric cooler to provide active cooling to at least some portion of the shaver that makes contact with the skin. The portion of the shaver which is actively cooled is thermally connected to the cold side of the thermoelectric cooler either by direct contact with the cold side of the thermoelectric cooler or through a heat conductive member(s) placed between the portion of the shaver which is to be actively cooled and the cold side of the thermoelectric cooler to transfer thermal energy. Such a heat conductive member normally has a relatively high thermal conductivity such as metallic substances, including without limitation, copper, aluminum, silver, gold, brass, steel, conductor filled polymers, metallic alloys, metal matrix composites, etc. The conductive member may be covered with thermal insulation along its surfaces not in contact with the cold side of the thermoelectric cooler and not in contact with the cooled portion of the shaver to increase the heat transfer effectiveness of the conductive member. The actively cooled portion of the shaver cools the skin of the user by conducting thermal energy away from the skin since the temperature on the actively cooled portion of the shaver is maintained at a temperature lower than the skin temperature of the user. The average, normal dry skin temperature of a human is approximately 32-33° C. As the temperature of the actively cooled portion of the shaver drops farther below the skin temperature, the more of a cooling sensation the user will experience since the amount of conduction heat transfer is proportional to the difference in temperature between the skin surface and the cooled portion of the shaver in contact with the skin. A warm blooded organism generates thermal energy by metabolism within living cells, and as that thermal energy is lost to the surroundings, in this case the cooled portion of the shaver, a cooling sensation is felt.

The thermoelectric cooler requires a direct current power supply of a particular polarity to cause the thermal energy to flow in the desired direction. In the various embodiments of the present invention, the power supply source may be either batteries or a continuous direct current power supply, an example of which is a common household alternating current to direct current power converter. In at least one embodiment where an alternating current to direct current power converter is used, the conversion of the alternating current power to direct current power normally occurs external to the shaver for safety reasons. Typical power consumption levels of thermoelectric coolers of the size useful for some embodiments of this application to electric shavers are generally on the order of a watt to 10 watts. Embodiments requiring large cooled surfaces may require more power consumption.

In order to control the temperature of the actively cooled portion of the shaver, a temperature sensor is employed in at least one embodiment and is attached to the cold side of the thermoelectric cooler or near the cooled portion of the shaver. The temperature sensor may be, without limitation, a thermistor, a resistance temperature detector (RTD), a thermocouple, a semiconductor temperature sensor, or similar electronic sensor whereby an electronic circuit may determine the approximate temperature where the sensor is placed. Control electronics compare the temperature of the sensor to a temperature set point as a user controlled temperature setting in one embodiment. If the temperature of the sensor is greater than the set point, the electronic circuit supplies power to the thermoelectric cooler for a set period of time (as a non-limiting example, 2 seconds) then the temperature sensor is polled again by the control electronics and compared to the temperature set point. Electric power is supplied to the thermoelectric cooler as controlled by the control electronics until the temperature sensor output is equal to or less than the temperature set point at which time the control electronics terminates electrical power to the thermoelectric cooler for a set time period (as a non-limiting example, 2 seconds). The temperature sensor is polled again and the temperature control loop continues to maintain the thermoelectric cooler cold side and actively cooled portion of the shaver at the approximate desired temperature. In one embodiment, the control electronics comprising a microprocessor based circuit with input and output ports control the feedback loop with the temperature sensor and the thermoelectric cooler. For at least one embodiment for the application described herein, the temperature control system described above is sufficient since highly accurate temperature control is generally unnecessary. In other embodiments, more complex temperature controllers may be used including but not limited to a PID (Proportional, Integral, Differential) controller or a PWM (Pulse Width Modulation) controller for more accurate temperature control but with generally added complexity and cost.

In one embodiment to minimize complexity and cost and to maximize dependability, there is no variable temperature control, temperature sensor, or control electronics present. In this embodiment, the thermoelectric cooler cools continuously at a fixed power unless it is switched off by the user whereupon it does no active cooling.

Various heat sink configurations are used in the various embodiments of the invention. In one embodiment, the heat sink in thermal contact with the hot side of the thermoelectric cooler comprises a container filled with a phase change material (PCM) whereby the latent heat of fusion of the material is used to absorb thermal energy as the material melts. One advantage of using PCM as a heat sink is that it is passive. It is also a regenerative system, in that the molten material will return to a solid phase to be used again after it rejects its latent heat of fusion. Also, during the change of phase from a solid to a liquid, the heat sink employing PCM will remain at constant temperature.

One example of a PCM that may be used as a heat sink material is a hydrated salt or a mixture of hydrated salts, nucleating agents to minimize supercooling of the salts in a molten state, and thickening or gelling agents to inhibit phase separation. One non-limiting example of a nucleating agent is borax and one non-limiting example of a thickening or gelling agent is gelatin. A properly selected hydrated salt or hydrated salt compound makes for an excellent heat sink due to its phase change behavior absorbing thermal energy without increasing the temperature of the salt until all of the solid salt crystals have melted. One non-limiting example of a hydrated salt suitable for this application is sodium sulfate decahydrate which has a melting temperature of approximately 30-32° C. and has a latent heat of fusion of at least 250 kJ/kg. Another example of a hydrated salt compound involves a combination of anhydrous sodium sulfate (one third by weight), a few percent by weight of sodium tetraborate decahydrate and the balance of water, the compound which also has a melting temperature of approximately 30-32° C. Many other hydrated salts or eutectic salts may be used individually or as compounds for the PCM.

Other PCM that may be used for passive heat sinks include, without limitation, encapsulated PCM's, paraffin compounds, organic compounds such as capric acid, lauric acid, stearic acid, and other fatty acids.

An example of an active heat sink configuration in another embodiment is the use of fan to force ambient air to impinge or flow across the hot side of the thermoelectric cooler. To enhance the heat transfer area, a thermally conductive structure with fins (similar to a heat sink structure affixed to heat generating electronic components such as CPU's) may be affixed to the hot side of the thermoelectric cooler to increase the wetted area over which the fan-forced ambient air flows. In those embodiments using a fan to actively cool the thermoelectric cooler, at least one inlet passage and at least one outlet passage are needed within the shaver body housing to allow ambient air to be ingested and exhausted (through flow) by the fan.

In yet another embodiment, a passive, non-phase changing thermal mass may be affixed to the hot side of the thermoelectric cooler to absorb thermal energy and act as a heat sink. Such a thermal mass would absorb thermal energy by increasing the sensible heat of the mass.

The embodiments of the invention are intended to be broad in scope with respect to electric shavers for both men and women including but not limited to single foil shavers, multiple foil shavers, rotating blade shavers, vibrating blade shavers, oscillating blade shavers, facial hair shavers, underarm hair shavers, leg hair shavers, bikini line hair shavers, epilators, etc.

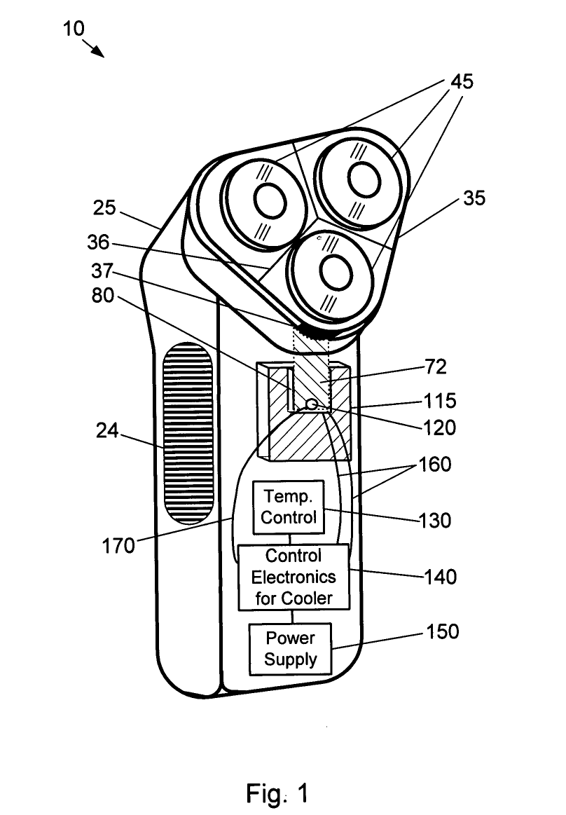

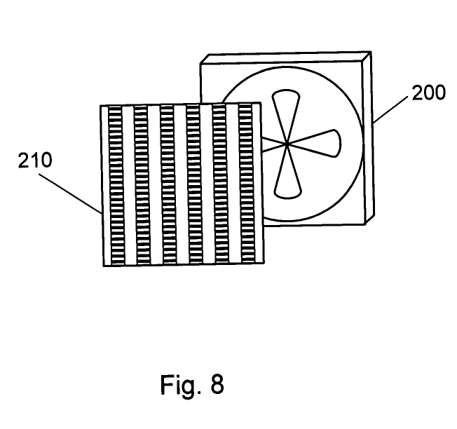

FIG. 1 shows one embodiment of the invention in the configuration of a multiple cutting head, rotary electric shaver 10. The shaver body housing 25 supports the shaving head 35, which includes the cutting heads 45, and encloses or supports the internal components of the shaver including a power supply 150, control electronics for the thermoelectric cooler 140, a user activated temperature control 130, at least one thermoelectric cooler 80, a heat sink system 115, a conductive member 72, a temperature sensor 120 contacting the cold side of the thermoelectric cooler 80, electrical conductors 160 to power the thermoelectric cooler 80, and a temperature sensor cable 170 connecting the temperature sensor 120 to the control electronics 140 for thermoelectric cooler 80. The power supply 150 may either be rechargeable batteries, one-time use batteries, or simply an electrical connector to receive and pass through power from an external power source such as an alternating current to direct current adapter. The power supply 150 provides electrical power to at least the control electronics for the thermoelectric cooler 140, the thermoelectric cooler 80, and a cooling fan 200 (See FIG. 8) if the heat sink system 115 utilizes a cooling fan 200 as shown in the thermoelectric cooling system shown in FIG. 8. The power supply 150 may also power the other functions of the shaver 10 such as operating a blade driver element to drive the hair cutting blades as is well known in the art and not shown in FIG. 1. The blade driver element may comprise an electric motor, an electromechanical oscillator to produce laterally oscillating blade motion or similar blade drivers known in the art. Each of the cutting heads 45 comprise hair cutting blades covered by a skin guard element to protect skin from directly contacting the blades while letting hair protrude through to the blades. The skin guard elements are the visible part of the cutting heads 45 in FIG. 1. The blades are below the skin guard elements in the cutting heads 45 and are comprised of any blade configurations known in the art.

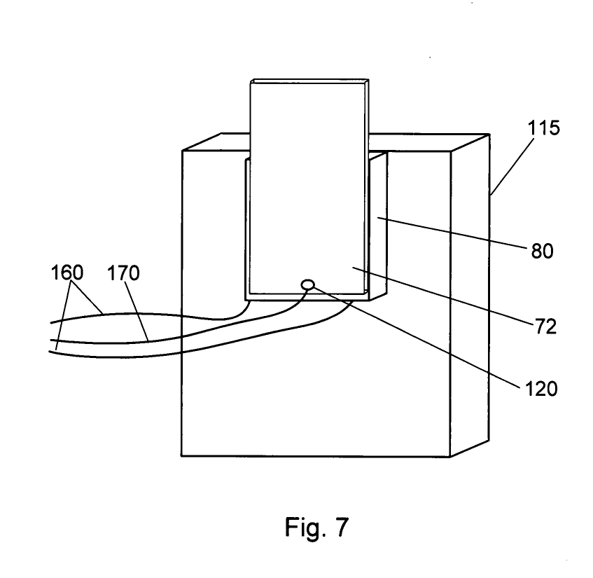

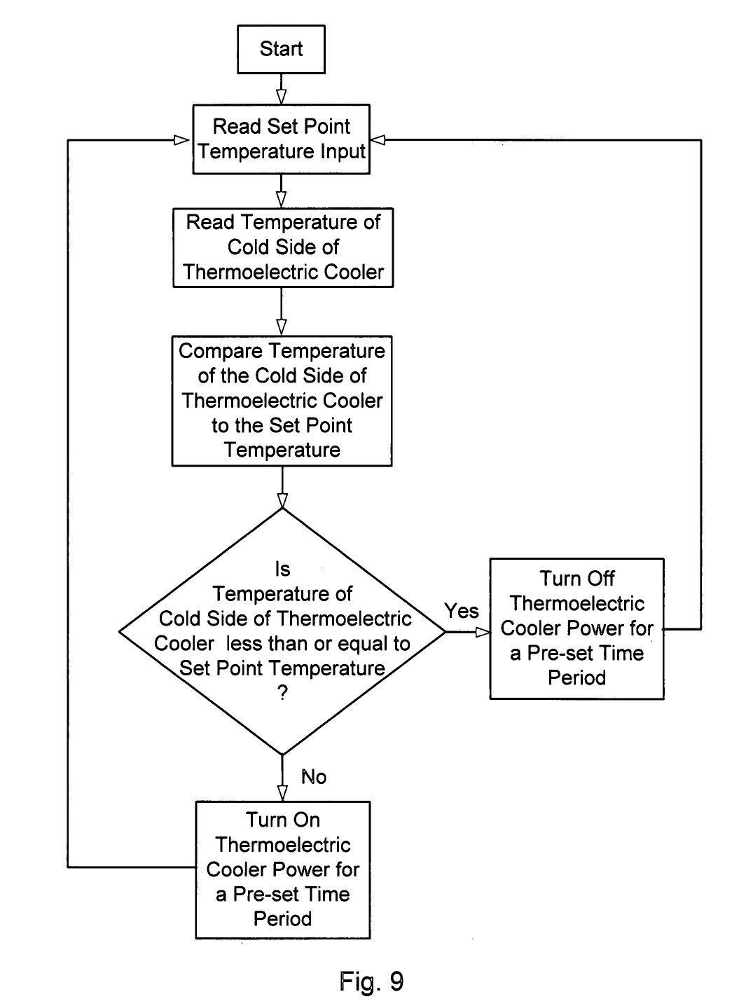

In order to operate the embodiment as shown in FIG. 1, the user controls the thermoelectric cooler 80 by operating the temperature control 130 which is a user operable control such as a variable resistor, digital selector, or other electronic control to set the temperature of the cold side of the thermoelectric cooler 80 which controls the temperature in the conducting member 72. In one embodiment, the thermoelectric cooler 80 can be turned off by setting the temperature control 130 to the highest temperature. In another embodiment, a separate control switch (not shown) may be user selected to turn off the thermoelectric cooler 80 and fan 200 that may be used to cool the hot side of the thermoelectric cooler 80 if a fan is used in that particular heat sink system 115 embodiment (FIG. 7). With the temperature control 130 set to the desired setting, the control electronics 140 controls the temperature of the cold side of the thermoelectric cooler 80 through feedback using input from the temperature sensor 120 connected to the control electronics 140. In one embodiment, a feedback system is used to control the temperature of the cold side, the operation of which is illustrated in the flow chart in FIG. 9. The position of the temperature control 130 defines the set point temperature as an electronic input to the control electronics 140. It is understood that in some embodiments, the position of the temperature control 130 may not have a temperature graduated scale visible to the user or other temperature indicia output to be read by the user but rather the relative position of the temperature control 130 between its minimum and maximum setting may serve as feedback to the user for relative temperature selection. In other embodiments there is a graduated scale incorporated with the temperature control for user reference. The control electronics 140 polls the temperature sensor 120 which may comprise a thermistor, a resistance temperature detector (RTD), a thermocouple, a semiconductor temperature sensor, or similar electronic temperature sensor. The control electronics 140 uses an analog to digital converter in one embodiment to acquire data from the temperature control 130 and temperature sensor 120. The control electronics then compares the set point temperature to the temperature of the sensor 120. If the temperature of the temperature sensor 120 is less than the set point temperature, then the power is turned off to the thermoelectric cooler 80 for a set time period. If the temperature of the sensor is greater than or equal to the set point temperature of the sensor 120, then the power is turned on to the thermoelectric cooler 80 for a set time period. After each set time period the temperature control 130 and the temperature sensor 120 are polled again by the control electronics 140 and the control process continues. The set time periods are not typically user adjustable and are set during manufacture. These time periods are normally from about half a second up to few seconds to provide reasonable control over the temperature on the cold side 90 of the thermoelectric cooler 80 and thereby provide temperature control on the actively cooled portion of the shaver which includes the conductive member 72 and the portion of the shaving head 35 attached to the conductive member 72. This temperature control system is sufficient for this application where exact temperature levels are not needed. Small amounts of temperature overshoot in the control system are easily tolerated in this application. In another embodiment, should more exact temperature control be desired, commonly used PID (proportional integral, differential) closed loop controllers or PWM (pulse width modulation) closed loop controllers or similar well know feedback-control schemes may be employed to control the temperature of the cold side 90 of the thermoelectric cooler 80.

The shaving head 35, or portion thereof, is cooled by contact with the cooled conducting member 72 in one embodiment since the conducting member 72 is also in contact with the cold side of the thermoelectric cooler 80. An example thermal contact area 37 between the conduction member 72 and shaving head 35 is illustrated in FIG. 1. To enhance thermal contact between surfaces of the conducting member 72 and the cold side of the thermoelectric cooler 80, a thermal interface material is used such as metallic filled or conductive adhesives, zinc oxide paste, solder, thermal grease or other thermal fillers. The same or similar thermal interface material is used between the hot side of the thermoelectric cooler 80 and a surface of the heat sink system 115. A thermal interface material may optionally be used between the thermal conducting member 72 and the shaving head 35 at the thermal control area 37. The portion of the shaving head 35 to be actively cooled is comprised of a high thermal conductivity material, such as but not limited, to a metal. Cooling of the user's skin occurs when the actively cooled portion of the shaver contacts the skin. Thermal energy from the user's skin is transferred to the cold side 90 of the thermoelectric cooler 80 where it is absorbed and rejected to the heat sink system 115. In one embodiment, the actively cooled portion may be used independently of the shaver hair cutting function and the shaver hair cutting function may be used independently of the cooling function. In another embodiment, the hair cutting function and the cooling function are used simultaneously.

It is understood that the actively cooled portion of the shaving head 35 as shown in FIG. 1 may not include the entire shaving head 35. Only a portion of the shaving head 35 may be cooled to permit more intense cooling over a smaller area of the shaver. Optional thermal insulating material segments 36 such as plastic materials or air gaps between adjacent portions of the shaving head 35 provide significant thermal segregation of the adjacent portions in one embodiment.

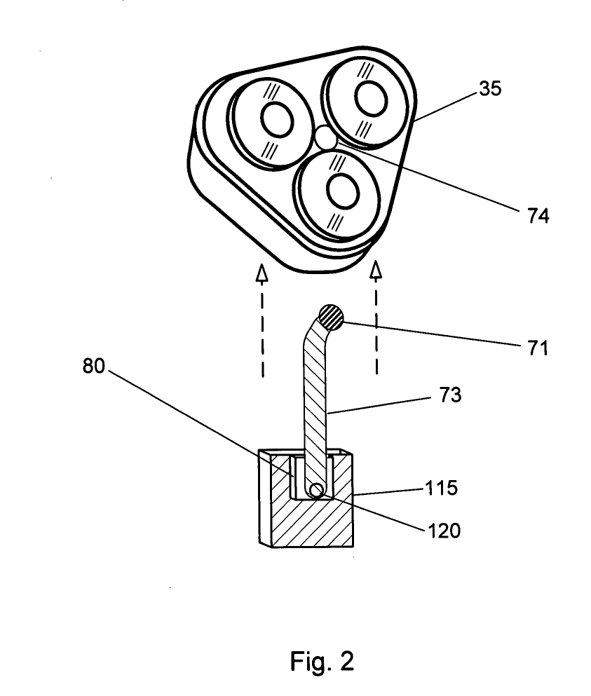

In another embodiment, a conductive protuberance 71 (FIG. 2) is formed or attached on the end of the conductive member 73 to provide the actively cooled portion to make contact with the skin of the user. This conductive protuberance 71 may also extend into the center or near center of the multiple head region of a shaver in another embodiment as shown in FIG. 2. Here, an aperture 74 near the center of the shaving head 35 allows for passage of the conductive protuberance 71 which makes contact with the skin to provide cooling action. It is understood that such an aperture 74 and conductive protuberance 71 may exist singularly or as a plurality distributed over the surface of the shaving head 35 even though FIG. 2 illustrates a singular configuration. A utility of the conductive protuberance 71 extending through the aperture 74 is that the shaving head 35 may be easily removed from the shaver body housing 25 (FIG. 1) for cleaning and maintenance without disturbing or removing components of the cooling system.

In another embodiment, the temperature control 130 is not present in which case the thermoelectric cooler 80 operates at one power input level at all times.

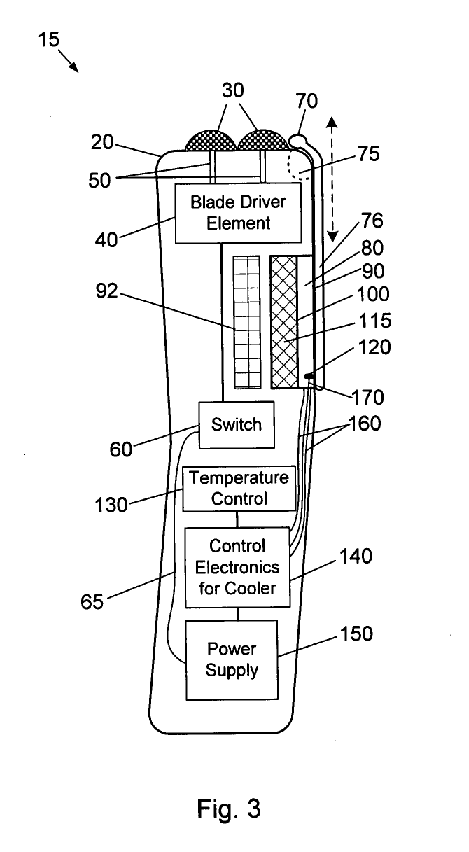

FIG. 3 illustrates, in side view, another embodiment of the invention in the form of a foil head, electric shaver 15. While two foil heads 30 are shown in FIG. 3, as an example, any number of foil heads maybe used. The shaver body housing 20 supports the shaving head, which includes the foil heads 30, and encloses or supports the internal components of the shaver 15 including a power supply 150, a blade driver element 40 for driving hair cutting blades contained within in the foil heads 30, blade driver element linkage 50 to actuate the blades within the foil heads 30, a power switch 60 for the blade driver element 40, and a power cable 65 between the power supply 150 and the power switch 60, control electronics for the thermoelectric cooler 140, a user activated temperature control 130, at least one thermoelectric cooler 80, a heat sink system 115 contacting the hot side 100 of the thermoelectric cooler 80, a conductive member 76 contacting the cold side 90 of the thermoelectric cooler 80, a temperature sensor 120 contacting the cold side 90 of the thermoelectric cooler 80, electrical conductors 160 to power the thermoelectric cooler 80, and a temperature sensor cable 170 connecting the temperature sensor 120 to the control electronics for thermoelectric cooler 140. The power supply 150 may either be rechargeable batteries, one-time use batteries, or a simple electrical connector to receive and pass through power from an external power source such as an alternating current to direct current adapter. The power supply 150 provides electrical power to at least the control electronics 140, the thermoelectric cooler 80, and a cooling fan 200 (See FIG. 8) if the heat sink system 115 utilizes a cooling fan 200 as shown in the thermoelectric cooling system shown in FIG. 8. The power supply 150 may also power the other functions of the shaver 15 such as powering the blade driver element 40 to operate the blades when the power switch 60 is turned on. The blade driver element 40 may comprise an electric motor, an electromechanical oscillator to produce laterally oscillating blade motion or similar blade drivers known in the art. Each of the foil heads 30 comprise hair cutting blades covered by a skin guard element to protect skin from directly contacting the blades while letting hair protrude through to the blades. The skin guard elements are the visible part of the foil heads 30. The blades are below the skin guard element of the foil heads 30 and are comprised of any blade configurations known in the art. In this embodiment, the skin guard elements are the perforated foils of the foil heads 30.

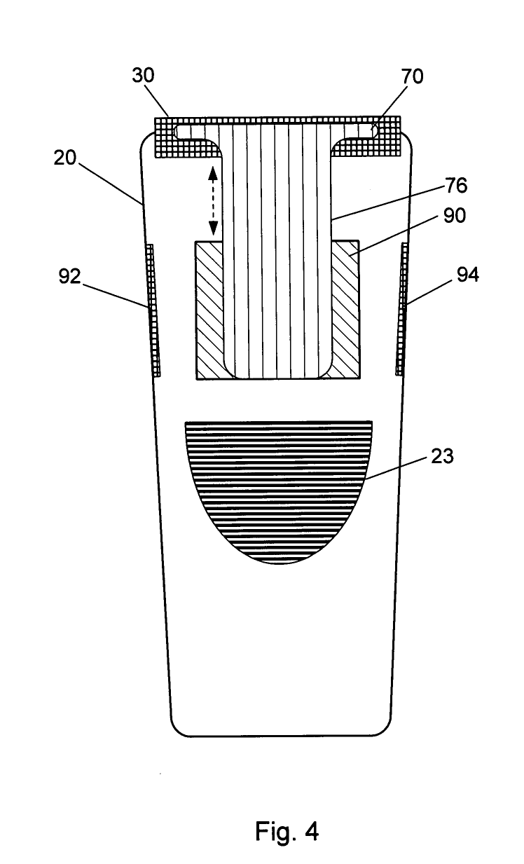

In order to operate the embodiment as shown in FIG. 3, the user controls the thermoelectric cooler 80 by operating the temperature control 130 which is a user operable control such as a variable resistor, digital selector, or other electronic control to set the temperature of the cold side 90 of the thermoelectric cooler 80 which controls the temperature in the conductive member 76. In one embodiment, the thermoelectric cooler 80 can be turned off by setting the temperature control 130 to the highest temperature. In another embodiment, a separate control switch (not shown) may be user selected to turn off the thermoelectric cooler 80 and fan 200 that may be used to cool the hot side 100 of the cooler 80 if a fan 200 is used in that particular heat sink system 1 15 embodiment (FIG. 8). Also, if a fan 200 is used, an inlet flow passage 92 through the shaver body housing 20 is needed to allow ambient to air be ingested and an outlet flow passage 94 (FIG. 4) is needed to exhaust the air through the shaver body housing 20. With the temperature control 130 set to the desired setting, the control electronics 140 controls the temperature of the cold side 90 of the thermoelectric cooler 80 through feedback using input from the temperature sensor 120 connected to the control electronics 140. In one embodiment, an electronic feedback system is used to control the temperature of the cold side as illustrated in the flow chart in FIG. 9. The position of the temperature control 130 defines the set point temperature as an electronic input to the control electronics 140. It is understood that in some embodiments, the position of the temperature control 130 may not have a temperature graduated scale visible to the user or other temperature indicia output to be read by the user but rather the relative position of the temperature control 130 between its minimum and maximum setting may serve as feedback to the user for relative temperature selection. In other embodiments there is a graduated scale incorporated with the temperature control for user reference. The control electronics 140 polls the temperature sensor 120 which may comprise a thermistor, a resistance temperature detector (RTD), a thermocouple, a semiconductor temperature sensor, or similar electronic temperature sensor. The control electronics 140 uses an analog to digital converter in one embodiment to acquire data from the temperature control 130 and temperature sensor 120. The control electronics then compares the set point temperature to the temperature of the sensor 120. If the temperature of the temperature sensor 120 is less than the set point temperature, then the power is turned off to the thermoelectric cooler 80 for a set time period. If the temperature of the sensor is greater than or equal to the set point temperature of the sensor 120, then the power is turned on to the thermoelectric cooler 80 for a set time period. After each set time period the temperature control 130 and the temperature sensor 120 are polled again and the control process continues. The set time periods are not typically user adjustable and are set during manufacture. These time periods are normally from about half a second up to few seconds to provide reasonable control over the temperature on the cold side 90 of the thermoelectric cooler 80 and thereby on the actively cooled portion of the shaver. This temperature control system is sufficient for this application where exact temperature levels are not needed. Small amounts of temperature overshoot in the control system are easily tolerated in this application. In another embodiment, should more exact temperature control be desired, commonly used PID (proportional integral, differential) closed loop controllers or PWM (pulse width modulation) closed loop controllers or similar well know feedback-control schemes may be employed to control the temperature of the cold side 90 of the thermoelectric cooler 80.

The conductive member 76 is cooled by contact with the cold side 90 of the thermoelectric cooler 80 and the skin contact bar 70 is cooled by contact with the conductive member 76. Both the conductive member 76 and the skin contact bar 70 are constructed of a material with high thermal conductivity such as but not limited to metal or metal alloys. The skin contact bar 70 has a smooth finish to provide comfort to the skin as it slides across the skin during the act of shaving or cooling the skin. The skin contact bar 70 may take on any shape that is comfortable to the skin such as but not limited to cylindrical, flat, convex, round, ellipsoid, etc. In one embodiment, the skin contact bar 70 may be removed from the conductive member 76 for replacement if needed. The skin contact bar 70 makes contact with the skin of the user to cool the skin. The conductive member 76 and the skin contact bar 70 are retractable in one embodiment whereby the skin contact bar 70 fits inside of a receptacle 75 in the shaver body housing 20 when in the retracted position. In the embodiment with a retractable skin contact bar 70, the user manually extends and retracts the conductive member 76 as desired by sliding the conductive member 76 along the shaver body housing 20. Sliding of the conductive member 76 causes the member to slide along the cold side 90 surface of a fixed thermoelectric cooler 80 in one embodiment, or causes the thermoelectric cooler 80 to move along with the motion of the sliding conductive member 76 in another embodiment.

To enhance thermal contact between surfaces of the conducting member 76 and the cold side 90 of the thermoelectric cooler 80, a thermal interface material is used such as a metallic filled adhesive, zinc oxide paste, solder, thermal grease or other thermal fillers. The same or similar thermal interface material is used between the hot side 100 of the thermoelectric cooler 80 and a surface of the heat sink system 115. Cooling of the user's skin occurs when the actively cooled skin contact bar 70 contacts the user's skin. In one embodiment, the actively cooled skin contact bar 70 may be used independently of the shaver hair cutting function and the shaver hair cutting function may be used independently of the cooling function. In another embodiment, the hair cutting function and the cooling function are used simultaneously.

FIG. 4 shows the rear view of the foil head shaver embodiment shown in FIG. 3 and described above. A grip 23 on the shaver body housing 20 facilitates holding of the shaver by the user. FIG. 4 also illustrates one example embodiment of how the conductive member 76 may transition into the skin contact bar 70 and how the skin contact bar 70 moves to retract and extend. Inlet flow passage 92 through the shaver body housing 20 permits ambient air to be ingested by fan 200 (FIG. 8) and outlet flow passage 94 through the shaver body housing 20 permits the ingested ambient air to be exhausted if a fan 200 is used in the heat sink system 115. The air flow moves past the hot side of the thermoelectric cooler 80 to convect away thermal energy. The inlet flow passage 92 and outlet flow passage 94 are not needed if a passive system such as a phase change material is used in the heat sink system 115.

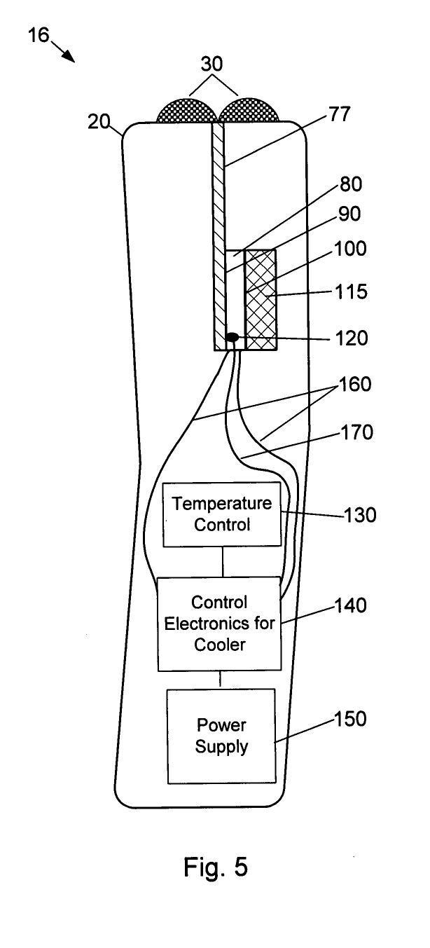

FIG. 5 illustrates another embodiment of the invention using a foil head shaver 16. This embodiment functions the same as the embodiments illustrated in FIG. 3 and described above with the exception that a conductive member 77 cools the foil heads 30 which contact the skin instead of another conductive member 76 cooling a skin contact bar 70 (FIGS. 3 and 4). The perforated foils of the foil heads 30 shown in FIGS. 3 and 4 serve as the skin guard elements and cover the conventional blades of the shaver in this embodiment.

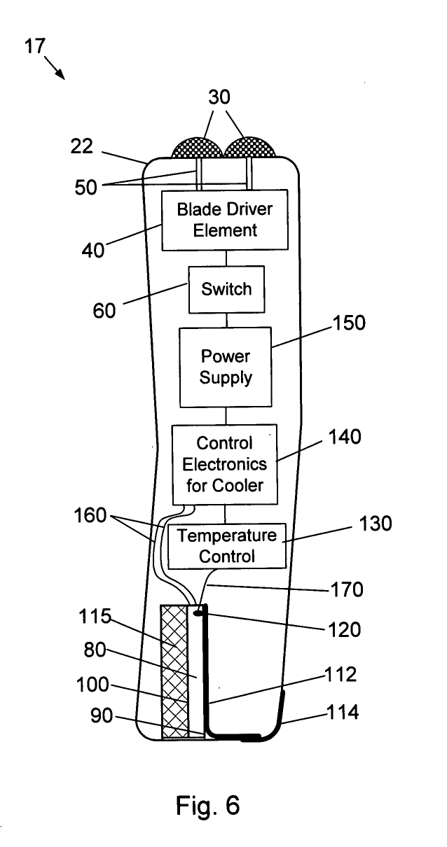

FIG. 6 illustrates yet another embodiment of a shaver 17, where the actively cooled region which contacts the skin may be anywhere on the shaver body housing 22. In this embodiment, a thermally conductive surface 114 on the shaver body housing 22 is thermally connected to the cold side 90 of a thermoelectric cooler 80 within the shaver body housing 22. The thermal connection between the thermally conductive surface 114 and the cold side 90 of the thermoelectric cooler 80 is achieved by a thermally conductive element 112 which is a metallic strip or rod as non-limiting examples. The thermally conductive surface 114 is a conductive material such as but not limited to metals and thermal conductor filled polymers. The location of the conductive surface 114 may be anywhere on the exterior of the shaver body housing 22 and is intended to apply to foil head shavers, multiple head shavers, rotary head shavers and other shaver configurations without limitation. In this embodiment, using the conductive surface 114 to cool the skin can be done prior to or after shaving by moving the conductive surface in contact with the skin.

One thermoelectric cooling system embodiment used in the various embodiments of the invention is shown in FIG. 7. The thermoelectric cooler 80 is sandwiched between a heat sink system 115 and a conductive member 72. The heat sink system 115 abuts to the hot side of the thermoelectric cooler 80 in order to absorb thermal energy from the thermoelectric cooler 80. The conductive member 72 abuts to the cold side of the thermoelectric cooler to release thermal energy into the thermoelectric cooler 80, thereby cooling the conductive member 72. The thermoelectric cooler is powered by electrical conductors 160. A temperature sensor 120 measures the temperature of the cold side of the thermoelectric cooler and provides data feedback via cable 170 to the control electronics 140 to maintain temperature control of the thermoelectric cooler 80. It is understood that conductive member 72 can be replaced with conductive members 73, 76, 77, or conductive element 112 and maintain the same function for the respective embodiments described herein.

The heat sink system 115 is a passive system in one embodiment comprising a container holding a phase change material (PCM) such as but not limited to hydrated salts, hydrated salt compounds, paraffin compounds, organic compounds such as capric acid, lauric acid, stearic acid, and other fatty acids. The latent heat of fusion is absorbed as the PCM changes from a solid to a liquid, while remaining at a constant temperature. Once all of the mass of the PCM has changed phase completely, it will continue to absorb sensible heat and increase in liquid temperature. After a period of time when the thermoelectric cooler 80 has been turned off, the PCM will reject its latent heat of fusion thereby solidifying and be ready for use again to absorb thermal energy from the thermoelectric cooler 80. Another passive system embodiment of the heat sink system 115 is the use of a thermal mass that simply absorbs sensible heat and does not undergo a phase change. Such systems usually require larger volumes of heat sink material than those undergoing a phase change. Typically used materials are, without limitation, high heat capacity liquids and/or metals.

Another embodiment of a heat sink system 115 of FIG. 7 is shown in FIG. 8 where the heat sink system 115 comprises an electric fan 200 blowing ambient air across a finned heat sink element 210. The finned heat sink element 210 is abutted to the hot side of the thermoelectric cooler 80 to remove thermal energy from the hot side. The finned heat sink element 210 is composed of a high surface area, high thermal conductivity material similar to heat sinks used to cool electrical components such as CPU's of desktop computers. In one embodiment, the electric fan 200 is a miniature axial fan of the configuration typically used to cool personal computer electrical components. In another embodiment, the fan blows ambient air on the hot side of the thermoelectric cooler without the need for a finned heat sink element 210.

The various preferred embodiments described above are merely descriptive of the present invention and are in no way intended to limit the scope of the invention. Modification of the present invention will become obvious to those skilled in the art in light of the detailed description above, and such modifications are intended to fall within the scope of the appended claims.

What is claimed:

1. An electric shaver apparatus comprising:
a shaving head for cutting hair;
a thermoelectric cooler;
the thermoelectric cooler thermally connected to at least a portion of the shaving head to actively cool the portion of the shaving head; and
a heat sink system thermally connected to the thermoelectric cooler.

2. The electric shaver apparatus of claim 1 wherein the actively cooled portion of the shaving head comprises a skin guard element.

3. The electric shaver apparatus of claim 1 wherein the heat sink system comprises at least a phase change material.

4. The electric shaver apparatus of claim 1 wherein the heat sink system comprises at least a fan.

5. The electric shaver apparatus of claim 1 further comprising a user adjustable temperature control and control electronics to maintain the temperature of the cold side of the thermoelectric cooler.

6. An electric shaver apparatus comprising:
a shaving head for cutting hair;
a thermoelectric cooler comprising a cold side and a hot side;
the cold side of the thermoelectric cooler thermally connected to at least one portion of the shaving head to actively cool the at least one portion of the shaving head;
a heat sink system thermally connected to the hot side of the thermoelectric cooler;
a temperature sensor connected to the thermoelectric cooler;
control electronics connected to the thermoelectric cooler and the temperature sensor; and
a user operable temperature control connected to the control electronics to control the approximate temperature of the actively cooled at least one portion of the shaving head.

7. The electric shaver apparatus of claim 6 wherein the heat sink system comprises at least a phase change material.

8. The electric shaver apparatus of claim 6 wherein the heat sink system comprises at least an electric fan.

9. An electric shaver apparatus comprising:
a shaving head comprising an aperture;
a thermoelectric cooler comprising a cold side and a hot side;
the cold side of the thermoelectric cooler thermally connected to a conductive protuberance;
the conductive protuberance positioned through the aperture in the shaving head; and
a heat sink system thermally connected to the hot side of the thermoelectric cooler.

10. The electric shaver apparatus of claim 9 wherein the heat sink system comprises at least a phase change material.

11. The electric shaver apparatus of claim 9 wherein the heat sink system comprises at least an electric fan.

12. An electric shaver apparatus comprising:
a shaving head for cutting hair close to the skin of a person;
a thermoelectric cooler comprising a cold side and a hot side;
a heat sink system thermally connected to the hot side of the thermoelectric cooler; and
a skin contact bar thermally connected to the cold side of the thermoelectric cooler.

13. The electric shaver apparatus of claim 12 wherein the heat sink system comprises at least a phase change material.

14. The electric shaver apparatus of claim 12 wherein the heat sink system comprises at least an electric fan.

15. The electric shaver apparatus of claim 12 wherein the skin contact bar is retractable.

16. A shaver apparatus comprising:
electrically driven blades for cutting body hair close to the skin of a user;
a thermoelectric cooler comprising a cold side and a hot side;
a heat sink system thermally connected to the hot side of the thermoelectric cooler;
a shaver body housing containing at least the thermoelectric cooler; and
the cold side of the thermoelectric cooler thermally connected to a thermally conductive surface exterior to the shaver body housing.

17. The electric shaver apparatus of claim 16 wherein the heat sink system comprises at least a phase change material.

18. The electric shaver apparatus of claim 16 wherein the heat sink system comprises at least an electric fan.

19. The shaver apparatus of claim 16 wherein the shaver body housing has an inlet passage and an outlet passage to allow through flow of ambient air.

20. A method for cutting body hair near the skin of a person and providing active cooling comprising the steps of:
powering a shaving head of an electric shaver;
cutting hair from the skin;
cooling a portion of the shaving head by a thermoelectric cooler; and
contacting the cooled portion of the shaving head with the skin of the person.
